(19) United States
(12) Patent Application Publication
(10) Pub. No.: US 2026/0284587 A1
(43) Pub. Date: Sep. 24, 2026

(54) ADSORPTION-MEMBRANE-DISTILLATION DIRECT AIR CAPTURE SYSTEMS AND METHODS

(71) Applicant: Georgia Tech Research Corporation, Atlanta, GA (US)

(72) Inventors: Ryan P. Lively, Atlanta, GA (US); Matthew Realff, Atlanta, GA (US)

(21) Appl. No.: 19/576,975

(22) Filed: Mar. 24, 2026

Related U.S. Application Data
(60) Provisional application No. 63/776,411, filed on Mar. 24, 2025.

(51) Int. Cl. B01D 53/22; B01D 53/06; B01D 53/26; F25J 3/04

(52) U.S. Cl. CPC B01D 53/229; B01D 53/06; B01D 53/265; F25J 3/04636; B01D 2053/221; B01D 2256/22; B01D 2257/504; B01D 2257/80; B01D 2259/4009; F25J 2205/60; F25J 2205/80

(57) ABSTRACT

The present disclosure relates generally to carbon dioxide capture systems and methods, and more particularly to direct air capture systems and methods that combine adsorption, membrane separation, and distillation technologies to capture and purify carbon dioxide from ambient air. A direct air capture system includes a first separation stage configured to receive an air stream containing carbon dioxide and to produce a first enriched stream having a higher carbon dioxide concentration than the air stream. The direct air capture system includes a second separation stage configured to receive the first enriched stream and to produce a second enriched stream having a higher carbon dioxide concentration than the first enriched stream. The first separation stage and the second separation stage employ different separation technologies selected from the group consisting of adsorption, membrane separation, and distillation.

### CROSS-REFERENCE TO RELATED APPLICATIONS

This application claims the benefit of U.S. Provisional Application Serial No. 63/776,411, filed on 24 Mar. 2025, which is incorporated herein by reference in its entirety as if fully set forth below.

### FIELD OF INVENTION

The present disclosure relates to carbon dioxide capture systems and methods, and more particularly to direct air capture systems and methods that combine adsorption, membrane separation, and distillation technologies to efficiently capture and purify carbon dioxide from ambient air.

### BACKGROUND

The field of carbon dioxide capture from atmospheric air, commonly referred to as direct air capture, has emerged as an area of technological development aimed at reducing atmospheric carbon dioxide concentrations. Various separation technologies have been applied to this challenge, including adsorption-based systems, membrane separation systems, and distillation processes. Adsorption-based direct air capture systems typically employ solid sorbent materials that selectively bind carbon dioxide from air streams, with the captured carbon dioxide subsequently released through temperature swing or pressure swing regeneration cycles. Membrane separation systems utilize selective permeation of carbon dioxide through membrane materials to achieve separation from other atmospheric gases. Distillation processes separate carbon dioxide based on differences in boiling points between carbon dioxide and other components in a gas mixture.

Current direct air capture systems typically rely on a single separation technology to accomplish the entire separation from ambient air concentrations of approximately 400 parts per million to high purity carbon dioxide suitable for storage or utilization. Adsorption-based systems, while effective at capturing carbon dioxide from dilute air streams, face challenges when attempting to produce high purity carbon dioxide in a single stage, often requiring extended cycle times and complex equipment designs. Membrane separation systems demonstrate varying efficiency depending on the feed gas concentration, with performance characteristics that differ substantially between dilute and concentrated carbon dioxide streams. Distillation processes, while capable of producing high purity carbon dioxide, require substantial energy inputs when processing dilute feed streams. These single-technology approaches often result in elevated energy consumption, extended processing times, and increased capital costs associated with equipment sized to handle the complete separation in one system.

What is needed, therefore, is an improved direct air capture system and method that combines multiple separation technologies in a manner that allows each technology to operate within its most efficient concentration range. Such a system would reduce overall energy consumption compared to single-technology approaches while enabling faster processing cycles and potentially lower capital costs through improved equipment productivity.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a direct air capture system can include a first separation stage configured to receive an air stream containing carbon dioxide and to produce a first enriched stream having a higher carbon dioxide concentration than the air stream. The direct air capture system can include a second separation stage configured to receive the first enriched stream and to produce a second enriched stream having a higher carbon dioxide concentration than the first enriched stream. The first separation stage and the second separation stage employ different separation technologies selected from the group consisting of adsorption, membrane separation, and distillation.

According to another aspect of the present disclosure, a method for capturing carbon dioxide from air can include directing an air stream containing carbon dioxide to a first separation stage. The method can include concentrating the carbon dioxide in the first separation stage to produce a first enriched stream having a higher carbon dioxide concentration than the air stream. The method can include directing the first enriched stream to a second separation stage. The method can include concentrating the carbon dioxide in the second separation stage to produce a second enriched stream having a higher carbon dioxide concentration than the first enriched stream. The first separation stage and the second separation stage employ different separation technologies selected from the group consisting of adsorption, membrane separation, and distillation.

According to another aspect of the present disclosure, a direct air capture system can include an adsorption stage including a rotary adsorber configured to receive an air stream containing carbon dioxide and to produce a first enriched stream having a carbon dioxide concentration higher than the air stream. The direct air capture system can include a mechanical vapor recompression system configured to receive a desorbed mixture from the rotary adsorber and to separate water from carbon dioxide. The direct air capture system can include a membrane separation stage configured to receive a stream from the mechanical vapor recompression system and to produce a second enriched stream having a higher carbon dioxide concentration than the first enriched stream. The direct air capture system can include a distillation stage configured to receive the second enriched stream and to produce liquid carbon dioxide having a higher carbon dioxide concentration than the second enriched stream.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a graph showing second law efficiency as a function of feed concentration for different separation technologies.

FIG. 2 illustrates a graph showing work for separation as a function of feed gas CO₂ composition for different separation technologies.

FIG. 3 illustrates an adsorption-membrane-distillation direct air capture system, according to examples of the disclosed technology.

FIG. 4 illustrates an adsorption-membrane-distillation direct air capture system with exemplary operating parameters, according to examples of the disclosed technology.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to direct air capture systems and methods for capturing carbon dioxide from air. Direct air capture (DAC) refers to processes that remove carbon dioxide (CO₂) from ambient air, where the concentration of CO₂ is approximately 400 parts per million (ppm). Capturing CO₂ at such dilute concentrations presents challenges in terms of energy consumption and capital costs.

Different separation technologies exhibit varying efficiencies depending on the concentration of the target component in the feed stream. Temperature swing adsorption (TSA) can operate efficiently at low feed concentrations, such as those found in ambient air. Membrane separation can operate efficiently at intermediate feed concentrations. Distillation can operate efficiently at high feed concentrations approaching pure CO₂. By combining multiple separation technologies in sequence, with each technology operating within a feed concentration range where that technology exhibits favorable efficiency characteristics, the overall energy consumption for the separation can be reduced compared to approaches that rely on a single separation technology to accomplish the entire separation.

A direct air capture system according to the present disclosure can include a first separation stage configured to receive an air stream containing carbon dioxide and to produce a first enriched stream having a higher carbon dioxide concentration than the air stream. The direct air capture system can further include a second separation stage configured to receive the first enriched stream and to produce a second enriched stream having a higher carbon dioxide concentration than the first enriched stream. The first separation stage and the second separation stage can employ different separation technologies selected from the group consisting of adsorption, membrane separation, and distillation. In some cases, the direct air capture system can include a third separation stage that employs a separation technology different from those employed by the first separation stage and the second separation stage.

A method for capturing carbon dioxide from air according to the present disclosure can include directing an air stream containing carbon dioxide to a first separation stage and concentrating the carbon dioxide in the first separation stage to produce a first enriched stream having a higher carbon dioxide concentration than the air stream. The method can further include directing the first enriched stream to a second separation stage and concentrating the carbon dioxide in the second separation stage to produce a second enriched stream having a higher carbon dioxide concentration than the first enriched stream. The first separation stage and the second separation stage can employ different separation technologies selected from the group consisting of adsorption, membrane separation, and distillation.

In some cases, the direct air capture system can employ adsorption as the first separation stage, membrane separation as the second separation stage, and distillation as the third separation stage. This arrangement, referred to herein as adsorption-membrane-distillation direct air capture (AMD-DAC), can leverage the efficiency characteristics of each separation technology within the concentration range where that technology performs favorably. The AMD-DAC system can achieve a total energy consumption of approximately 3-5 gigajoules (GJ) per tonne of CO₂ captured. The AMD-DAC system can operate at steady state rather than batch mode operation, which can reduce capital costs and improve productivity of the separation media.

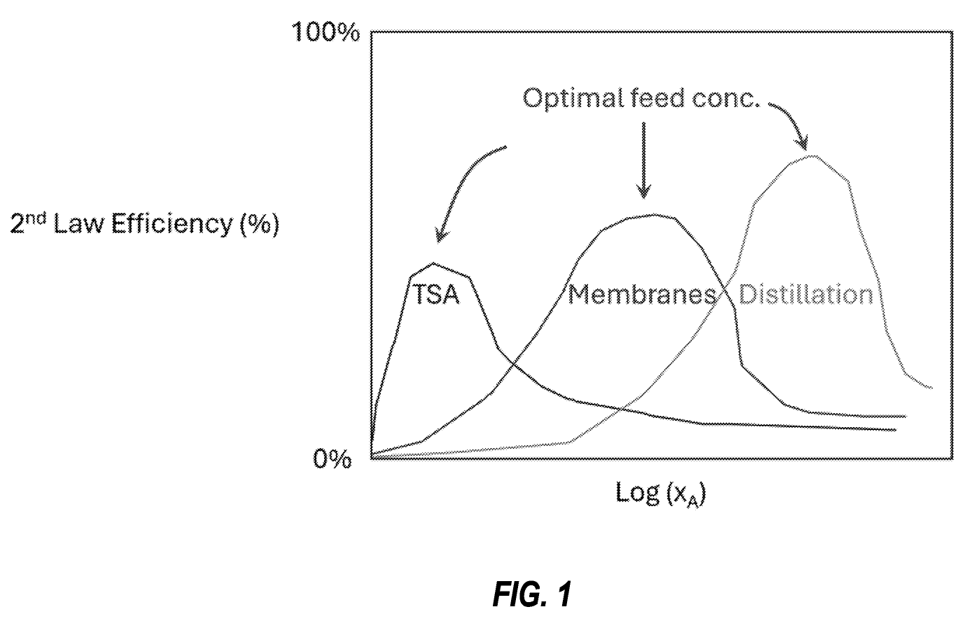

Referring to FIG. 1, a graph illustrates second law efficiency as a function of the logarithm of feed concentration for three different separation technologies used in direct air capture processes. The vertical axis represents second law efficiency expressed as a percentage, ranging from zero percent at the bottom to one hundred percent at the top. The horizontal axis represents the logarithm of the mole fraction of the target component in the feed stream.

Three curves are shown on the graph, each representing a different separation technology. A first curve labeled TSA represents temperature swing adsorption and shows a peak efficiency at low feed concentrations, positioned on the left side of the graph. A second curve labeled Membranes represents membrane separation technology and shows a peak efficiency at intermediate feed concentrations, positioned in the middle region of the graph. A third curve labeled Distillation represents distillation separation technology and shows a peak efficiency at high feed concentrations, positioned on the right side of the graph.

With continued reference to FIG. 1, the curves demonstrate that each separation technology operates with favorable efficiency within a specific range of feed concentrations. Temperature swing adsorption can exhibit favorable efficiency characteristics at dilute concentrations, such as those found in ambient air where CO₂ concentration is approximately 400ppm. Membrane separation can exhibit favorable efficiency characteristics at moderate concentrations, such as those in the range of approximately 1 mol% to approximately 40 mol% CO₂. Distillation can exhibit favorable efficiency characteristics at higher concentrations approaching pure CO₂.

As further shown in FIG. 1, the efficiency of each separation technology decreases as the feed concentration moves away from the concentration range where that technology exhibits peak efficiency. For example, temperature swing adsorption can exhibit reduced efficiency at higher feed concentrations where membrane separation or distillation can perform more favorably. Similarly, distillation can exhibit reduced efficiency at dilute feed concentrations where temperature swing adsorption can perform more favorably. The second law efficiency analysis illustrated in FIG. 1 provides a basis for selecting and sequencing separation technologies in a multi-stage direct air capture system, where each stage can operate within a feed concentration range that corresponds to favorable efficiency characteristics for the separation technology employed in that stage.

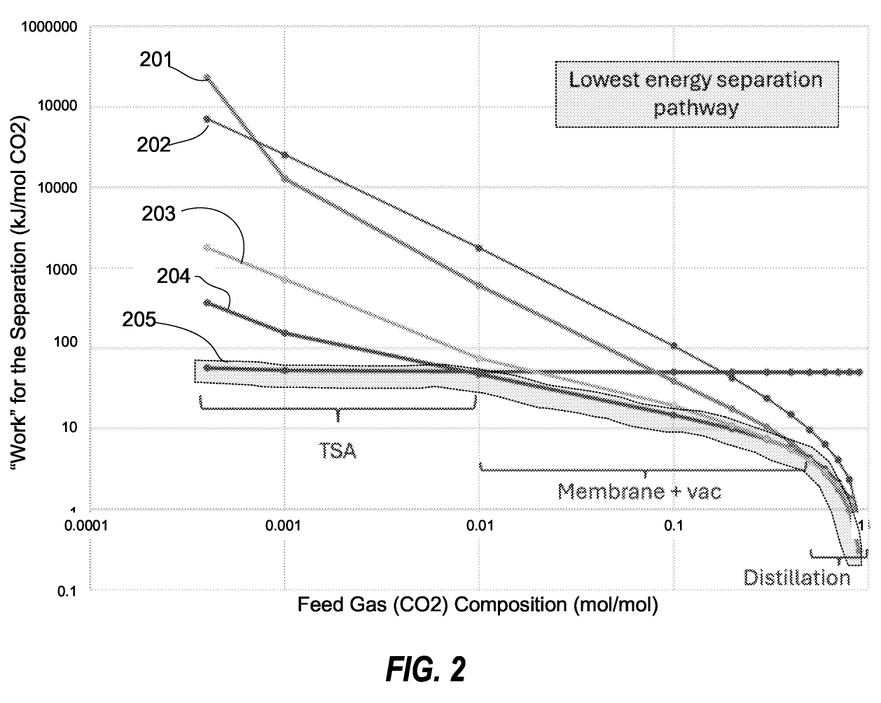

Referring to FIG. 2, a graph illustrates the relationship between feed gas CO₂ composition and the work required for separation, demonstrating the lowest energy separation pathway for different separation technologies. The x-axis represents feed gas CO₂ composition in mol/mol, ranging from 0.0001 to 1, while the y-axis represents work for the separation in kJ/mol CO₂, ranging from 1 to 1000000. Both axes are displayed on logarithmic scales.

The graph includes multiple curves representing different separation technologies. A distillation work curve 201 shows the work requirements for distillation as a function of feed gas CO₂ composition. The distillation work curve 201 exhibits the highest work requirements at low CO₂ concentrations and decreases as concentration increases. A membrane with feed compression work curve 202 displays work requirements for membrane separation using feed compression, with the work requirements decreasing as CO₂ concentration increases.

With continued reference to FIG. 2, a membrane with vacuum side compression selectivity=10 work curve 203 shows work requirements for membrane separation using vacuum side compression with a selectivity of 10. A membrane vacuum side compression selectivity=10 work curve 204 demonstrates work requirements for an alternative membrane vacuum side compression configuration, also with a selectivity of 10. The membrane vacuum side compression selectivity=10 work curve 204 exhibits work requirements in an intermediate range between the other membrane configurations.

A TSA work curve 205 shows the work requirements for temperature swing adsorption as a function of feed gas CO₂ composition. The TSA work curve 205 exhibits the lowest work requirements at very low CO₂ concentrations, with the curve extending from approximately 0.0001 mol/mol. As shown in FIG. 2, the TSA work curve 205 demonstrates that temperature swing adsorption can provide favorable energy performance at dilute CO₂ concentrations corresponding to ambient air.

As further shown in FIG. 2, a shaded region and highlighted pathway (surrounded by dashed line) on the graph illustrate the lowest energy separation pathway, which transitions between different technologies depending on the feed gas composition. The lowest energy separation pathway follows the TSA work curve 205 at low concentrations corresponding to ambient air, transitions to membrane separation at intermediate concentrations, and transitions to distillation at high concentrations approaching 1 mol/mol. The graph demonstrates that no single separation technology provides the lowest work requirements across the entire range of feed gas compositions. By transitioning between separation technologies at appropriate concentration thresholds, the overall work for the separation can be reduced compared to approaches that rely on a single separation technology to accomplish the entire separation from ambient air concentrations to pure CO₂.

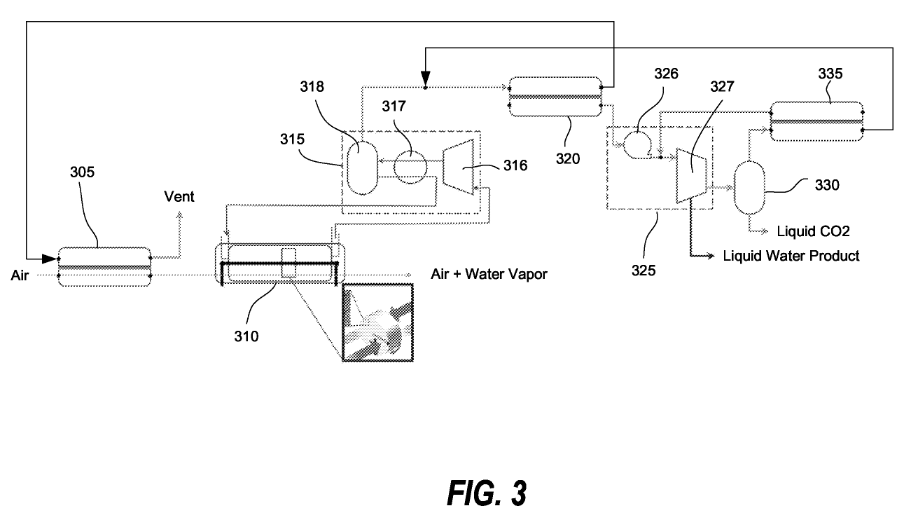

Referring to FIG. 3, a system diagram illustrates an adsorption-membrane-distillation direct air capture (AMD-DAC) system. The AMD-DAC system receives air as an input and produces liquid CO₂ and liquid water product as outputs. As described previously, the AMD-DAC system can employ adsorption as a first separation stage, membrane separation as a second separation stage, and distillation as a third separation stage. The third separation stage can be configured to receive a second enriched stream and to produce a third enriched stream having a higher carbon dioxide concentration than the second enriched stream. The third separation stage can employ a separation technology selected from the group consisting of adsorption, membrane separation, and distillation that is different from the separation technologies employed by the first separation stage and the second separation stage.

Air enters the system and passes through a CO₂ exchange membrane 305 positioned upstream of the first separation stage. The CO₂ exchange membrane 305 can be configured to transfer carbon dioxide from a recycle stream to the air stream to produce an enriched air stream having a higher carbon dioxide concentration than the air stream. The CO₂ exchange membrane 305 operates without a pressure driving force, allowing CO₂ to permeate across based on a concentration gradient. The CO₂ exchange membrane 305 can be referred to herein as a carbon dioxide exchange membrane.

With continued reference to FIG. 3, the enriched air stream from the CO₂ exchange membrane 305 flows into a rotary adsorber 310. The rotary adsorber 310 can be configured to receive an air stream containing carbon dioxide and to produce a first enriched stream having a carbon dioxide concentration higher than the air stream. The rotary adsorber 310 can be configured to rotate adsorbent material through the air stream to capture carbon dioxide and through a regeneration zone to release captured carbon dioxide. The rotary adsorber 310 can be configured to rotate at a relatively fast rate compared to conventional rotary adsorption systems. Fast rotation can provide high productivity on the adsorption step, which can reduce capital costs by enabling more carbon dioxide to be processed per unit of adsorbent material. In some cases, conventional rotary adsorption systems may take approximately 40 to 50 minutes per rotation, whereas the rotary adsorber 310 can complete a rotation in approximately 5 minutes or less. The fast rotation can achieve a modest carbon dioxide concentration, such as approximately 1 mol% to approximately 2 mol%, rather than attempting to achieve very high concentrations in a single pass. The first separation stage can comprise an adsorption system, and the rotary adsorber 310 can form part of the adsorption system. In some cases, the first separation stage can comprise an adsorption system and the second separation stage can comprise a membrane separation system.

The rotary adsorber 310 includes channels through which the air passes, and the CO₂ is adsorbed onto the adsorbent material within the rotary adsorber 310. A portion of the air exits through a vent after passing through the rotary adsorber 310. Saturated steam is used to desorb CO₂ from the rotary adsorber 310, where the steam condenses to apply heat to the rotary adsorber 310, which drives off the CO₂. The condensed water from steam desorption is evaporated on the adsorption side of the rotary adsorber 310 when exposed to high velocity air, which rapidly cools the rotary adsorber 310 back down. The desorbed stream comprising water vapor and carbon dioxide can be directed to a mechanical vapor recompression system.

As further shown in FIG. 3, the rotary adsorber 310 can be constructed using various adsorbent materials. The rotary adsorber 310 can be constructed using silica or alumina functionalized with polyethyleneimine (PEI) as the adsorbent material. The rotary adsorber 310 can use Lewatit as the adsorbent material. The rotary adsorber 310 can use zeolites functionalized with ethylene diamine as the adsorbent material. The rotary adsorber 310 can use Purolite or similar materials as the adsorbent material.

The rotary adsorber 310 can be configured in various structural arrangements. The rotary adsorber 310 can be configured as a conventional straight channel monolith rotated via an internal shaft. The rotary adsorber 310 can be configured with rotation driven by a motor but assisted by angular momentum of the air flowing through the rotary adsorber 310. The rotary adsorber 310 can be configured with spiraled or gyroidal channel designs to improve mass transfer rates. The rotary adsorber 310 can be manufactured using 3D printing to improve performance.

The mechanical vapor recompression system 315 can be configured to receive a desorbed mixture from the rotary adsorber 310 and to separate water from carbon dioxide. The mechanical vapor recompression system 315 includes a compressor 316, a heat exchanger 317, and a vapor liquid separator 318. The work for the mechanical vapor recompression system 315 is electrical in nature, which allows the process to be coupled to the grid or adjacent renewable energy sources.

The compressor 316 can be configured to compress a mixture of water vapor and carbon dioxide, raising the temperature of the mixture. The compressed vapor then passes through the heat exchanger 317. The heat exchanger 317 can be configured to transfer heat from the compressed mixture to a vaporizing water stream, which can be provided from the condensed water recycled from the vapor liquid separator 318 or from an external water source. The water vapor in the compressed mixture condenses while transferring heat to vaporizing water on the opposite side of the heat exchanger 317. The vapor liquid separator 318 can be configured to separate condensed water from a carbon dioxide enriched gas stream. The condensed water is recycled back to generate steam for the rotary adsorber 310, while the CO₂-enriched gas proceeds to the next stage.

As further shown in FIG. 3, the CO₂-enriched gas from the mechanical vapor recompression system 315 flows to a membrane separation system 320. The membrane separation system 320 can be configured to receive a stream from the mechanical vapor recompression system 315 and to produce a second enriched stream having a higher carbon dioxide concentration than the first enriched stream. The second separation stage can comprise a membrane separation system, and the membrane separation system 320 can form part of the second separation stage. The membrane separation system 320 further concentrates the CO₂ by separating the CO₂ from remaining water vapor and other gases.

A vacuum and compression system 325 provides the driving force for the membrane separation system 320. The vacuum and compression system 325 includes a vacuum 326 and a compressor 327 that work together to pull CO₂ through the membrane and compress the permeate stream.

With continued reference to FIG. 3, the concentrated CO₂ stream from the membrane separation system 320 enters a distillation system 330, which may also be referred to as a condenser or distillation system. The distillation system 330 can be configured to receive the second enriched stream and to produce liquid carbon dioxide having a higher carbon dioxide concentration than the second enriched stream. The third separation stage can comprise a distillation system, and the distillation system 330 can form part of the third separation stage. The distillation system 330 performs final purification of the CO₂ through phase separation at low temperature and high pressure and produces liquid CO₂ as a product stream and liquid water product as a separate output.

The overhead stream from the distillation system 330, which still contains CO₂, is directed to a membrane separation system 335 for additional CO₂ recovery. The recovered CO₂ from the membrane separation system 335 is recycled back to the carbon dioxide exchange membrane 305 at the front of the process to enrich the incoming air feed. The recycle stream from the distillation stage tops is recycled back to the beginning of the process at the carbon dioxide exchange membrane 305 rather than to an intermediate point.

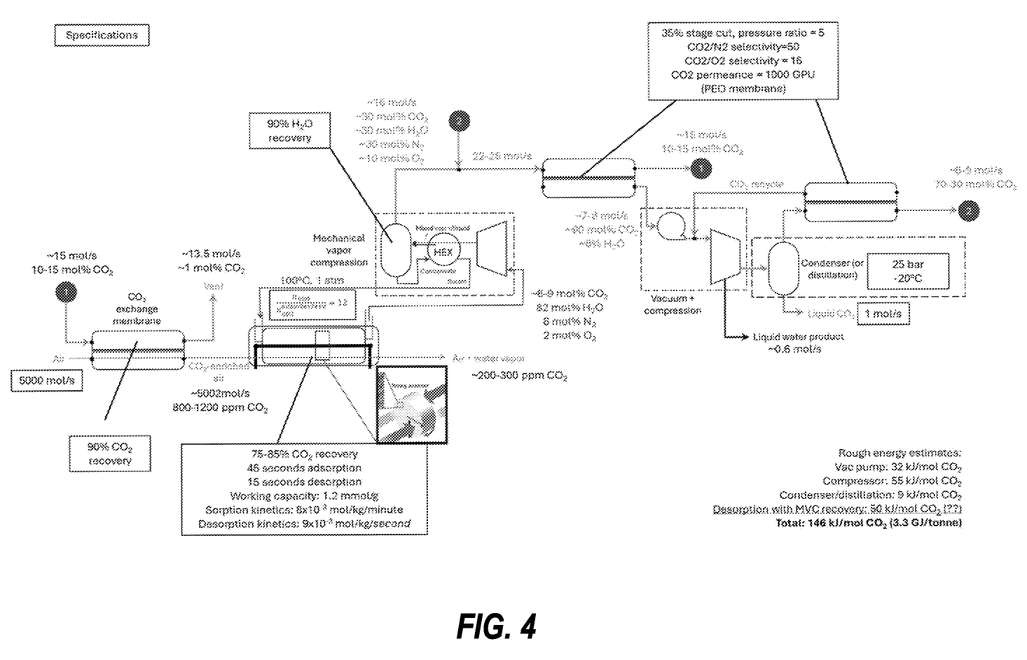

Referring to FIG. 4, a detailed process flow diagram illustrates the AMD-DAC system with exemplary operating parameters and specifications. The system receives ambient air at a flow rate of approximately 5000 mol/s, which first passes through the carbon dioxide exchange membrane where the incoming air contacts a CO₂-enriched recycle stream having approximately 15 mol/s at 10-15 mol% CO₂. The carbon dioxide exchange membrane enriches the incoming air to produce CO₂-enriched air at approximately 5002 mol/s with 800-1200ppm CO₂, while a vent stream exits at approximately 13.5 mol/s with approximately 1 mol% CO₂.

With continued reference to FIG. 4, the rotary adsorber can be configured to complete a rotation at a rate of at least ten rotations per hour. The rotary adsorber operates with approximately 45 seconds adsorption time and approximately 15 seconds desorption time, providing a fast cycle time of approximately 1 minute compared to 8-30 minutes for other adsorption systems. The rotary adsorber can complete a rotation approximately once every 5 minutes in some configurations. The rotary adsorber operates with a working capacity of approximately 1.2 mmol/g, adsorption kinetics of approximately 8x10⁻³ mol/kg/minute, and desorption kinetics of approximately 9x10⁻³ mol/kg/second. The adsorption process comprises rotating adsorbent material through the air stream to capture carbon dioxide and through a regeneration zone to release captured carbon dioxide, wherein the adsorbent material completes a rotation at a rate of at least ten rotations per hour.

As further shown in FIG. 4, the rotary adsorber achieves approximately 75-85% CO₂ recovery and produces an air stream with water vapor at approximately 200-300ppm CO₂ that exits the system. The first separation stage produces a first enriched stream having a carbon dioxide concentration of between about 8 mol% and about 10 mol% in the steam/CO₂ mixture before water condensation. Concentrating the carbon dioxide in the first separation stage produces the first enriched stream having a carbon dioxide concentration of between about 1 mol% and about 4 mol% in the air/steam mixture exiting the rotary adsorber, which corresponds to the carbon dioxide concentration of the first enriched stream as recited in the claims. The rotary adsorber can be configured to produce the first enriched stream having a carbon dioxide concentration of between about 1 mol% and about 4 mol%, and in some embodiments, between about 1 mol% and about 2 mol%.

With continued reference to FIG. 4, the desorbed stream from the rotary adsorber enters the mechanical vapor recompression system operating at 100° C. and 1 atm, with a water to CO₂ ratio in the adsorber feed of approximately 12. In some cases, the system can use low temperature vacuum steam instead of 100° C., 1 atm steam for desorption from the rotary adsorber as an alternative configuration. The mechanical vapor recompression system achieves approximately 90% H₂O recovery and produces an output stream at approximately 16 mol/s containing approximately 30 mol% CO₂, approximately 30 mol% H₂O, approximately 30 mol% N₂, and approximately 10 mol% O₂. The mechanical vapor recompression system produces a stream with approximately 20-30 mol% CO₂ concentration after water condensation.

The system consumes water rather than producing water due to the use of direct steam with high partial pressure of water during desorption. The use of saturated steam for desorption results in a higher amount of water in the vapor phase, which suppresses water adsorption onto the adsorbent material. Due to the high partial pressure of water in the vapor phase, water may actually adsorb onto the adsorbent material rather than desorb during the desorption process. This suppression of water desorption significantly reduces energy consumption compared to systems that do not employ this approach. Without the suppression of water adsorption provided by the high partial pressure of water in the vapor phase, energy consumption for the direct air capture process could be as high as approximately 15 to 20 GJ per tonne of CO₂ captured. The condensed water from steam desorption is evaporated on the adsorption side of the rotary adsorber 310 when exposed to high velocity air, which provides evaporative cooling to rapidly cool the rotary adsorber 310 back down.

As further shown in FIG. 4, the stream from the mechanical vapor recompression system proceeds to the membrane separation system utilizing a PEO membrane with specifications including approximately 35% stage cut, pressure ratio of approximately 5, CO₂/N₂ selectivity of approximately 50, CO₂/O₂ selectivity of approximately 16, and CO₂ permeance of approximately 1000 GPU. In some cases, the system can include an atmospheric water extraction (AWE) unit positioned ahead of the first membrane separation stage as an optional modification. The membrane produces a permeate stream at approximately 7-8 mol/s containing approximately 90 mol% CO₂ and approximately 8% H₂O, and a retentate stream at approximately 15 mol/s with 10-15 mol% CO₂. The membrane separation system produces a permeate stream with approximately 10 mol% CO₂ that is recycled to the carbon dioxide exchange membrane.

With continued reference to FIG. 4, the permeate stream passes through the vacuum and compression system, producing a stream at approximately 8-9 mol% CO₂, 82 mol% H₂O, 8 mol% N₂, and 2 mol% O₂. A liquid water product stream exits at approximately 0.6 mol/s. The compressed stream then enters the distillation system operating at approximately 25 bar and approximately -20° C., which produces liquid CO₂ through phase separation at low temperature and high pressure, achieving a higher carbon dioxide concentration than the second enriched stream, at approximately 1 mol/s and a CO₂ recycle stream. The distillation stage produces liquid CO₂ with purity greater than 99.9 mol%.

The rough energy estimates for the system include vacuum pump at approximately 32 kJ/mol CO₂, compressor at approximately 55 kJ/mol CO₂, condenser/distillation at approximately 9 kJ/mol CO₂, and desorption with mechanical vapor compression recovery at approximately 50 kJ/mol CO₂, yielding a total energy requirement of approximately 146 kJ/mol CO₂ or approximately 3.3 GJ/tonne, which falls within the range of approximately 3-5 GJ/tonne CO₂ that can be achieved by some embodiments of the AMD-DAC system.

The disclosed technology can be further understood according to the following clauses:

Clause 1: A direct air capture system, including: a first separation stage configured to receive an air stream containing carbon dioxide and to produce a first enriched stream having a higher carbon dioxide concentration than the air stream; and a second separation stage configured to receive the first enriched stream and to produce a second enriched stream having a higher carbon dioxide concentration than the first enriched stream, wherein the first separation stage and the second separation stage employ different separation technologies selected from the group consisting of adsorption, membrane separation, and distillation.

Clause 2: The direct air capture system of clause 1, further comprising a third separation stage configured to receive the second enriched stream and to produce a third enriched stream having a higher carbon dioxide concentration than the second enriched stream, wherein the third separation stage employs a separation technology selected from the group consisting of adsorption, membrane separation, and distillation that is different from the separation technologies employed by the first separation stage and the second separation stage.

Clause 3: The direct air capture system of clause 2, wherein the first separation stage comprises an adsorption system, the second separation stage comprises a membrane separation system, and the third separation stage comprises a distillation system.

Clause 4: The direct air capture system of clause 3, wherein the adsorption system comprises a rotary adsorber configured to rotate adsorbent material through the air stream to capture carbon dioxide and through a regeneration zone to release captured carbon dioxide.

Clause 5: The direct air capture system of clause 4, wherein the rotary adsorber is configured to complete a rotation at a rate of at least ten rotations per hour.

Clause 6: The direct air capture system of clause 4, further including a mechanical vapor recompression system configured to receive a desorbed stream from the rotary adsorber, the mechanical vapor recompression system including: a compressor configured to compress a mixture of water vapor and carbon dioxide; a heat exchanger configured to transfer heat from the compressed mixture to a vaporizing water stream; and a vapor liquid separator configured to separate condensed water from a carbon dioxide enriched gas stream.

Clause 7: The direct air capture system of clause 1, wherein the first separation stage comprises an adsorption system and the second separation stage comprises a membrane separation system.

Clause 8: The direct air capture system of clause 1, wherein the first enriched stream has a carbon dioxide concentration of between about 1 mol% and about 4 mol%.

Clause 9: The direct air capture system of clause 1, further comprising a carbon dioxide exchange membrane positioned upstream of the first separation stage and configured to transfer carbon dioxide from a recycle stream to the air stream to produce an enriched air stream having a higher carbon dioxide concentration than the air stream.

Clause 10: A method for capturing carbon dioxide from air, including: directing an air stream containing carbon dioxide to a first separation stage; concentrating the carbon dioxide in the first separation stage to produce a first enriched stream having a higher carbon dioxide concentration than the air stream; directing the first enriched stream to a second separation stage; and concentrating the carbon dioxide in the second separation stage to produce a second enriched stream having a higher carbon dioxide concentration than the first enriched stream, wherein the first separation stage and the second separation stage employ different separation technologies selected from the group consisting of adsorption, membrane separation, and distillation.

Clause 11: The method of clause 10, further comprising directing the second enriched stream to a third separation stage and concentrating the carbon dioxide in the third separation stage to produce a third enriched stream having a higher carbon dioxide concentration than the second enriched stream, wherein the third separation stage employs a separation technology selected from the group consisting of adsorption, membrane separation, and distillation that is different from the separation technologies employed by the first separation stage and the second separation stage.

Clause 12: The method of clause 11, wherein the first separation stage comprises an adsorption process, the second separation stage comprises a membrane separation process, and the third separation stage comprises a distillation process.

Clause 13: The method of clause 12, wherein the adsorption process comprises rotating adsorbent material through the air stream to capture carbon dioxide and through a regeneration zone to release captured carbon dioxide, wherein the adsorbent material completes a rotation at a rate of at least ten rotations per hour.

Clause 14: The method of clause 13, further comprising desorbing the captured carbon dioxide from the adsorbent material using steam and directing a desorbed stream comprising water vapor and carbon dioxide to a mechanical vapor recompression system.

Clause 15: The method of clause 10, further comprising transferring carbon dioxide from a recycle stream to the air stream through a carbon dioxide exchange membrane upstream of the first separation stage to produce an enriched air stream having a higher carbon dioxide concentration than the air stream prior to directing the air stream to the first separation stage.

Clause 16: The method of clause 10, wherein concentrating the carbon dioxide in the first separation stage produces the first enriched stream having a carbon dioxide concentration of between about 1 mol% and about 4 mol%.

Clause 17: A direct air capture system, including: an adsorption stage including a rotary adsorber configured to receive an air stream containing carbon dioxide and to produce a first enriched stream having a carbon dioxide concentration higher than the air stream; a mechanical vapor recompression system configured to receive a desorbed mixture from the rotary adsorber and to separate water from carbon dioxide; a membrane separation stage configured to receive a stream from the mechanical vapor recompression system and to produce a second enriched stream having a higher carbon dioxide concentration than the first enriched stream; and a distillation stage configured to receive the second enriched stream and to produce liquid carbon dioxide having a higher carbon dioxide concentration than the second enriched stream.

Clause 18: The direct air capture system of clause 17, wherein the rotary adsorber is configured to complete a rotation at a rate of at least ten rotations per hour.

Clause 19: The direct air capture system of clause 18, wherein the rotary adsorber is configured to produce the first enriched stream having a carbon dioxide concentration of between about 1 mol% and about 4 mol%.

Clause 20: The direct air capture system of clause 17, further comprising a carbon dioxide exchange membrane positioned upstream of the rotary adsorber and configured to transfer carbon dioxide from a recycle stream to the air stream to produce an enriched air stream having a higher carbon dioxide concentration than the air stream.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 wt.%” is intended to mean “about 40 wt.%”.

A number of implementations have been described. Nevertheless, it will be understood that various modifications may be made without departing from the spirit and scope of the disclosure. Accordingly, other implementations are within the scope of the following claims.

1. A direct air capture system, including:
a first separation stage configured to receive an air stream containing carbon dioxide and to produce a first enriched stream having a higher carbon dioxide concentration than the air stream; and
a second separation stage configured to receive the first enriched stream and to produce a second enriched stream having a higher carbon dioxide concentration than the first enriched stream,
wherein the first separation stage and the second separation stage employ different separation technologies selected from the group consisting of adsorption, membrane separation, and distillation.

2. The direct air capture system of claim 1, further comprising a third separation stage configured to receive the second enriched stream and to produce a third enriched stream having a higher carbon dioxide concentration than the second enriched stream, wherein the third separation stage employs a separation technology selected from the group consisting of adsorption, membrane separation, and distillation that is different from the separation technologies employed by the first separation stage and the second separation stage.

3. The direct air capture system of claim 2, wherein the first separation stage comprises an adsorption system, the second separation stage comprises a membrane separation system, and the third separation stage comprises a distillation system.

4. The direct air capture system of claim 3, wherein the adsorption system comprises a rotary adsorber configured to rotate adsorbent material through the air stream to capture carbon dioxide and through a regeneration zone to release captured carbon dioxide.

5. The direct air capture system of claim 4, wherein the rotary adsorber is configured to complete a rotation at a rate of at least ten rotations per hour.

6. The direct air capture system of claim 4, further including a mechanical vapor recompression system configured to receive a desorbed stream from the rotary adsorber, the mechanical vapor recompression system including:
a compressor configured to compress a mixture of water vapor and carbon dioxide;
a heat exchanger configured to transfer heat from the compressed mixture to a vaporizing water stream; and
a vapor liquid separator configured to separate condensed water from a carbon dioxide enriched gas stream.

7. The direct air capture system of claim 1, wherein the first separation stage comprises an adsorption system and the second separation stage comprises a membrane separation system.

8. The direct air capture system of claim 1, wherein the first enriched stream has a carbon dioxide concentration of between about 1 mol% and about 4 mol%.

9. The direct air capture system of claim 1, further comprising a carbon dioxide exchange membrane positioned upstream of the first separation stage and configured to transfer carbon dioxide from a recycle stream to the air stream to produce an enriched air stream having a higher carbon dioxide concentration than the air stream.

10. A method for capturing carbon dioxide from air, including:
directing an air stream containing carbon dioxide to a first separation stage;
concentrating the carbon dioxide in the first separation stage to produce a first enriched stream having a higher carbon dioxide concentration than the air stream;
directing the first enriched stream to a second separation stage; and
concentrating the carbon dioxide in the second separation stage to produce a second enriched stream having a higher carbon dioxide concentration than the first enriched stream,
wherein the first separation stage and the second separation stage employ different separation technologies selected from the group consisting of adsorption, membrane separation, and distillation.

11. The method of claim 10, further comprising directing the second enriched stream to a third separation stage and concentrating the carbon dioxide in the third separation stage to produce a third enriched stream having a higher carbon dioxide concentration than the second enriched stream, wherein the third separation stage employs a separation technology selected from the group consisting of adsorption, membrane separation, and distillation that is different from the separation technologies employed by the first separation stage and the second separation stage.

12. The method of claim 11, wherein the first separation stage comprises an adsorption process, the second separation stage comprises a membrane separation process, and the third separation stage comprises a distillation process.

13. The method of claim 12, wherein the adsorption process comprises rotating adsorbent material through the air stream to capture carbon dioxide and through a regeneration zone to release captured carbon dioxide, wherein the adsorbent material completes a rotation at a rate of at least ten rotations per hour.

14. The method of claim 13, further comprising desorbing the captured carbon dioxide from the adsorbent material using steam and directing a desorbed stream comprising water vapor and carbon dioxide to a mechanical vapor recompression system.

15. The method of claim 10, further comprising transferring carbon dioxide from a recycle stream to the air stream through a carbon dioxide exchange membrane upstream of the first separation stage to produce an enriched air stream having a higher carbon dioxide concentration than the air stream prior to directing the air stream to the first separation stage.

16. The method of claim 10, wherein concentrating the carbon dioxide in the first separation stage produces the first enriched stream having a carbon dioxide concentration of between about 1 mol% and about 4 mol%.

17. A direct air capture system, including:
an adsorption stage including a rotary adsorber configured to receive an air stream containing carbon dioxide and to produce a first enriched stream having a carbon dioxide concentration higher than the air stream;
a mechanical vapor recompression system configured to receive a desorbed mixture from the rotary adsorber and to separate water from carbon dioxide;
a membrane separation stage configured to receive a stream from the mechanical vapor recompression system and to produce a second enriched stream having a higher carbon dioxide concentration than the first enriched stream; and
a distillation stage configured to receive the second enriched stream and to produce liquid carbon dioxide having a higher carbon dioxide concentration than the second enriched stream.

18. The direct air capture system of claim 17, wherein the rotary adsorber is configured to complete a rotation at a rate of at least ten rotations per hour.

19. The direct air capture system of claim 18, wherein the rotary adsorber is configured to produce the first enriched stream having a carbon dioxide concentration of between about 1 mol% and about 4 mol%.

20. The direct air capture system of claim 17, further comprising a carbon dioxide exchange membrane positioned upstream of the rotary adsorber and configured to transfer carbon dioxide from a recycle stream to the air stream to produce an enriched air stream having a higher carbon dioxide concentration than the air stream.
